(19) United States
(12) Patent Application Publication
(10) Pub. No.: US 2024/0353808 A1
(43) Pub. Date: Oct. 24, 2024

(54) SYSTEMS AND METHODS FOR CONTROLLING SMART HOME DEVICES

(71) Applicant: Capital One Services, LLC, McLean, VA (US)

(72) Inventors: Haytham Yaghi, Oakton, VA (US); Tyler Maiman, Melville, NY (US); Samuel Yip, East Brunswick, NJ (US); Joshua Edwards, Carrollton, TX (US); Bryant Yee, Silver Spring, MD (US)

(21) Appl. No.: 18/303,277

(22) Filed: Apr. 19, 2023

(51) Int. Cl. G05B 19/042

(52) U.S. Cl. CPC G05B 19/042; G05B 2219/2642

(57) ABSTRACT

Disclosed embodiments may include a system for controlling smart home devices. The system may receive, from a router, a list of devices connected to a home network in a home. The system may determine, from the list of devices, a presence of one or more controllable smart devices, the one or more controllable smart devices operating on a schedule. The system may categorize the one or more controllable smart devices into function-based categories. The system may receive user data. The system may determine a duration of an absence of a user in the home based on the user data. The system may change the schedule of the one or more controllable smart devices based on the function-based category and the duration of the absence of the user.

### FIELD

The disclosed technology relates to systems and methods for controlling smart home devices. Specifically, this disclosed technology relates to a system that can determine when a user is away from home and estimate when a user will return home using received data (e.g., transaction card data) and interact with a home networking device (e.g., a router) to determine which smart home devices should be shut down to save resources or be turned on so that they are ready to use when the user returns home.

### BACKGROUND

Traditional systems and methods for controlling smart home devices typically require a user to complete a number of tasks. Previously, users would setup timers to turn lamps on and off. More connected devices may allow for user control via a user device such as a smartphone. However, this can still be cumbersome for users to complete all the tasks and manage a number of timers.

Accordingly, there is a need for improved systems and methods for controlling smart home devices. Embodiments of the present disclosure are directed to this and other considerations.

### SUMMARY

Disclosed embodiments may include a system for controlling smart home devices. The system may include one or more processors, and memory in communication with the one or more processors and storing instructions that, when executed by the one or more processors, are configured to cause the system to control smart home devices. The system may receive, from a router, a list of devices connected to a home network in a home. The system may determine, from the list of devices, a presence of one or more controllable smart devices, the one or more controllable smart devices operating on a schedule. The system may categorize the one or more controllable smart devices into function-based categories. The system may receive user data. The system may determine a duration of an absence of a user in the home based on the user data. The system may change the schedule of the one or more controllable smart devices based on the function-based category and the duration of the absence of the user.

Disclosed embodiments may include a system for controlling smart home devices. The system may include one or more processors, and memory in communication with the one or more processors and storing instructions that, when executed by the one or more processors, are configured to cause the system to control smart home devices. The system may receive first user data. The system may determine an initial prediction regarding an absence of a user from a home based on the first user data. The system may receive, from a router, a list of devices connected to a home network. The system may determine, from the list of devices, a presence of one or more controllable smart devices, the one or more controllable smart devices operating on a schedule based on the initial prediction. The system may categorize the one or more controllable smart devices into function-based categories. The system may receive second user data. The system may determine a revised prediction regarding the absence of the user in the home based on the second user data. The system may change the schedule of the one or more controllable smart devices based on the function-based category and a duration of the absence of the user.

Disclosed embodiments may include a system for controlling smart home devices. The system may include one or more processors, and memory in communication with the one or more processors and storing instructions that, when executed by the one or more processors, are configured to cause the system to control smart home devices. The system may receive, from a router, a list of devices connected to a home network at a home of a user. The system may determine, from the list of devices, a presence of one or more controllable smart devices, the one or more controllable smart devices operating on a schedule. The system may categorize the one or more controllable smart devices into function-based categories. When the user is away from the home, the system may iteratively receive return data regarding the user, determine a user return time estimate based on the return data and revise the schedule of the one or more controllable smart devices based on the function-based category and the user return time estimate.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for controlling smart home devices in accordance with certain embodiments of the disclosed technology.

FIG. 2A is a flow diagram illustrating an exemplary method for controlling smart home devices in accordance with certain embodiments of the disclosed technology.

FIG. 2B is a flow diagram illustrating an exemplary method for controlling smart home devices in accordance with certain embodiments of the disclosed technology.

FIG. 3 is block diagram of an example smart home control system used to provide controlling smart home devices, according to an example implementation of the disclosed technology.

FIG. 4 is block diagram of an example system that may be used to provide controlling smart home devices, according to an example implementation of the disclosed technology.

### DETAILED DESCRIPTION

The disclosed technology may include a system for controlling smart home devices that utilizes user data. The user data may be transaction data related to a transaction card (e.g., a credit card, debit card, smart card, etc.). The system may use the user data to determine an estimated time when the user will return home. Based on this determination, the system may interface with controllable smart home devices (via a home router) to change the operating schedule of the controllable smart home devices according to the estimated time that the user will return home.

Examples of the present disclosure related to systems and methods for controlling smart home devices. More particularly, the disclosed technology relates to interfacing with a home router and determining a list of controllable smart home devices, using user data (e.g., transaction data) to determine when a user will return home, and using the determination to change the schedule of the controllable smart home devices. The systems and methods described herein utilize, in some instances, machine learning models, which are necessarily rooted in computers and technology. Machine learning models are a unique computer technology that involves training models to complete tasks and make decisions. The present disclosure may involve a machine learning model that estimates a return time of a user from transaction data. This, in some examples, may involve using transaction input data, such as input data from purchases made on a credit card, applied to determine a time that the user is going to return home or a duration of the absence of the user, and may output a result of a duration or estimated time. Using a machine learning model in this way may allow the system to utilize transaction data to make an assumption about when a user will be returning to their home or place of residence. The system can therefore use this determination to save energy or prepare the home for the user's return accordingly. Furthermore, the system may use a separate machine learning model to categorize the controllable smart devices on the network into function-based categories and determine the usage of the appliance in each category using training data from other users. This may allow the system to determine how to appliances may be used, and select different appliances to be in different usage modality categories. These uses of machine learning models provide an advantage and improvement over prior technologies that because they allow for minimal input from the user, as the user data (e.g., transaction data from the user's credit or debit card) can be automatically received a used to determine an appropriate schedule for the controllable smart devices in the user's home. Additionally, in some embodiments, little to no user setup is required, as the system automatically scans the user's network and determines controllable smart devices, and how the devices should be controlled according to the schedule. Leveraging machine learning models and/or user data (e.g., transaction data) in this way may allow for a significant increase in the efficiency of homes and home appliances. This may allow users to continue about their daily lives more, while saving more energy, and worrying less about their appliances at home.

Furthermore, the systems and methods described herein also utilize, in some instances, graphical user interfaces, which are necessarily rooted in computers and technology. Graphical user interfaces are a computer technology that allows for user interaction with computers through touch, pointing devices, or other means. This, in some examples, may involve a list showing all the devices connected to a network, the controllable smart devices available, and the categories of the controllable smart devices, which may be ordered by a variety of options, for example, a time the device is indicated to turn on or being operating. The user may be able to provide input to a user device to dynamically change the graphical user interface to reorder the list of devices, add additional controllable smart devices, or drag-and-drop controllable smart devices from one category to another. The graphical user interface may also provide the user with an estimated time that the user will arrive home, and the user may be able to provide input to a user device to change the arrival time. As a result, the graphical user interface may display an updated arrival time. This may result in the graphical user interface reordering the list of devices and/or displaying an updated arrival time of the user. Using a graphical user interface in this way may allow the system to modify the outputs of the machine learning models to better fit the characteristics or desires of the user. This is an improvement over technologies that require a user to manually input an assortment of controllable smart home devices, as the system saves the user time by automatically finding and categorizing smart home devices and determines a time the user will be home using the user data; however, it also allows for the user to modify these estimates and predictions using the graphical user interface. Overall, the systems and methods disclosed have significant practical applications in the home automation field because of the noteworthy improvements of using user data (e.g., transaction data) and machine learning to aid in solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

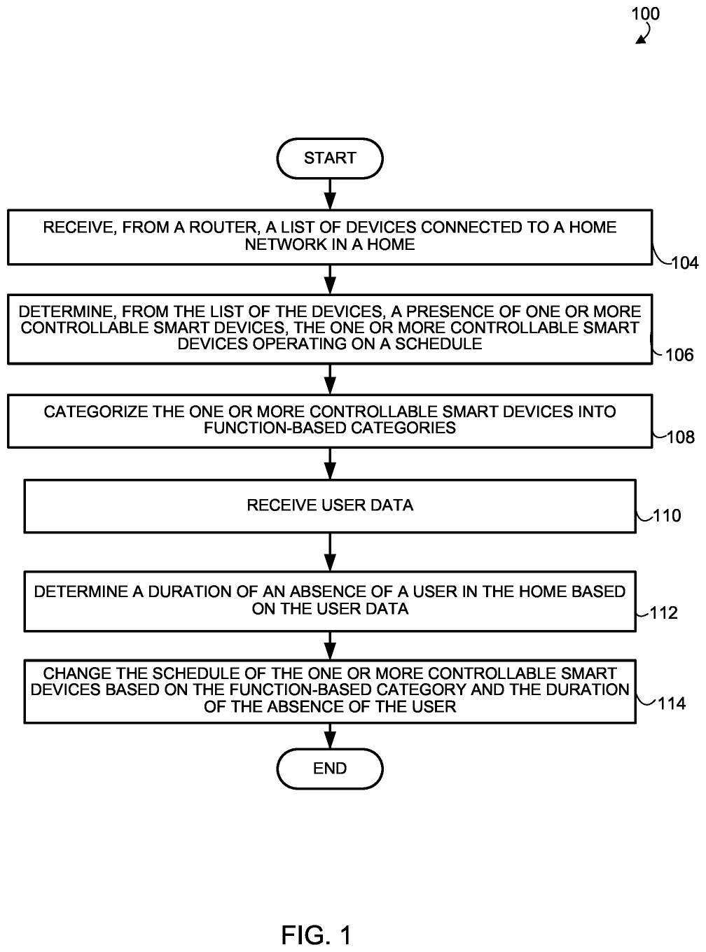

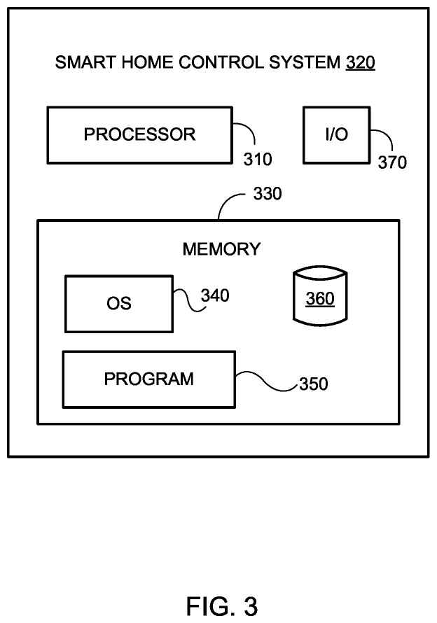

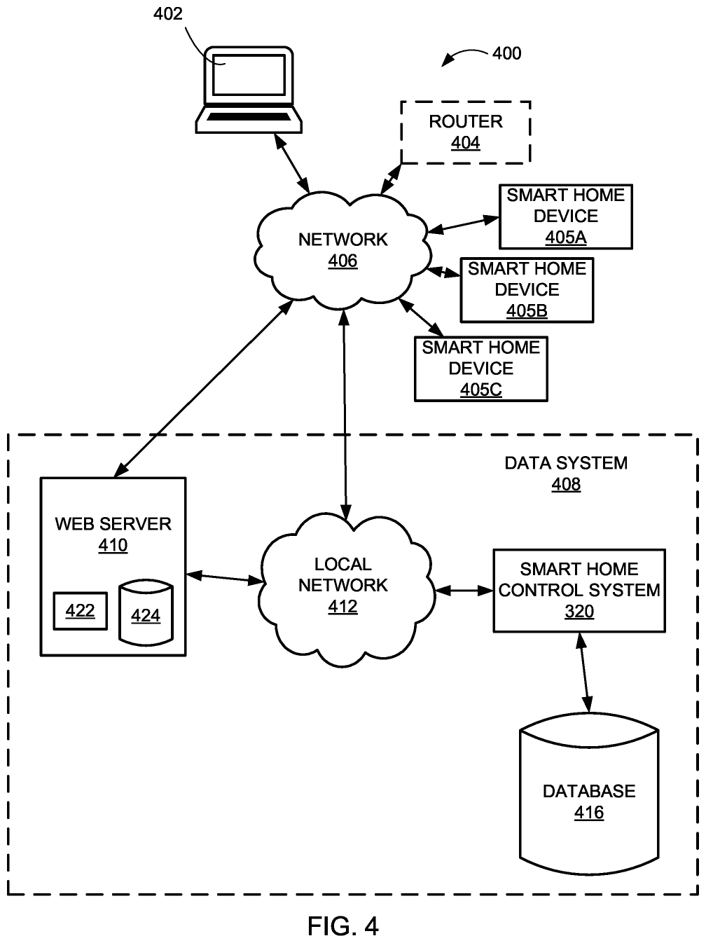

FIG. 1 is a flow diagram illustrating an exemplary method 100 for controlling smart home devices, in accordance with certain embodiments of the disclosed technology. The steps of method 100 may be performed by one or more components of the system 400 (e.g., smart home control system 320 or web server 410 of data system 408 or user device 402), as described in more detail with respect to FIGS. 3 and 4.

In block 104, the smart home control system 320 may receive, from a router 404, a list of devices 405 (405A, 405B, 405C) connected to a home network in a home. The smart home control system 320 may send a request to the router 404 to provide the list of devices connected to the home network. The router 404 may require the smart home control system 320 provide credentials such as a user name and password prior to receiving the list of devices connected to the home network. The list of devices connected to the home network may include a device name, or nickname, an internet protocol (IP) address, a media access control (MAC) address, information about the device (e.g., description, how long the device has been connected, how many times the device has connected and/or disconnected, manufacturer, model), device data usage (e.g., upload and download amounts), signal strength (e.g., WiFi™ signal strength), average signal strength, signal strength over time, among other information. The list may be in a table format.

In some embodiments, the system may receive the list of the devices connected to the home network from a user device. In this embodiment, the user device may have software that is capable of scanning the network to determine attached devices. The user device may then transmit the list of attached devices to the smart home control system 320. In other embodiments, the smart home control system 320 may be able to scan the network directly to determine attached devices 405. The smart home control system 320 may be able to receive an input from a user containing a list of attached devices 405. The smart home control system 320 may require the user device 402 to connect to a server located at the home when the user device 402 is away from the home. This may enable the user device 402 to scan for devices on the network when the user is away from home.

In block 106, the smart home control system 320 may determine, from the list of devices, a presence of one or more controllable smart devices. The smart home control system 320 may determine if one or more devices on the network is a controllable smart home device. (e.g., a smart TV or smart fridge). The smart home control system 320 may determine the presence of a smart device using the device name or nickname provided by the list of devices. If no device name or nickname is provided, the smart home control system 320 may reference the make or model of the device. The smart home control system 320 may also attempt to interact or communicate with devices on the network in order to identify the device.

In some embodiments, the smart home control system 320 may use a database (e.g., database 360 or database 416) of other user's devices located on other networks. Smart home control system 320 may compare attributes of an unknown device on the present network to the database of other user's devices on the network to determine if the unknown device has similarities to previous devices from other user's networks. For example, the smart home control system 320 may compare the download and upload pattern of an unknown device to that of a previous device (e.g., an unknown device pings a server every hour on the hour to specific web address A and prior device B was a smart dishwasher that pinged a server every hour on the hour to the same web address A, then smart home system 320 may assume that the unknown device is the same smart dishwasher). In some embodiments, the smart home control system 320 may use the signal strength or signal strength over time indication to determine if the unknown device is in a fixed location or moves and/or estimate how far the unknown device is from the router 404.

In some embodiments, the smart home control system 320 may receive data from a user device in order to determine the presence of the one or more controllable smart devices. The user device may transmit information to the smart home control system 320 comprising applications on a user device (e.g., applications specific to smart home devices), and access information for those applications (e.g., usernames and passwords). For example, the user's smartphone may transmit to the smart home control system a message indicating that the smartphone contains an app for a smart switch, and the username and password for the smart switch app. The smart home control system 320 may then search for a controllable smart switch device on the network and match the smart switch in the home to the app. The smart home control system 320 may utilize a database (such as database 360 or database 416) in order to match the app from the user device with a device on the network by analyzing for certain characteristics on the network, such as certain network traffic patterns.

In some embodiments, the one or more controllable smart devices may be operating on a schedule. The smart home control system 320 may interact or communicate with the controllable smart devices to determine or receive the schedule of the controllable smart devices. This may involve using an application programming interface (API) to interface with the controllable smart devices.

In some embodiments, the smart home control system 320 may receive user data. The user data may comprise transaction data from a transaction card, such as a credit or debit card. The transaction data may comprise purchase-level data from a transaction card, indicating specific items that were purchased by a user. The smart home control system 320 may determine, from the transaction data, that items purchased by a user correspond to controllable smart home devices 405. The smart home control system 320 may then search for controllable smart home devices 405 matching the items purchased by the user with devices on the network. The smart home control system 320 may utilize a database (such as database 360 or database 416) in order to match the item indicated by the purchase with a device on the network by analyzing for certain characteristics on the network, such as certain network traffic patterns.

In block 108, the smart home control system 320 may categorize the one or more controllable smart devices into categories. In coordination with, or separately from block 106, the smart home control system 320 may categorize the devices on the network into categories. Categories may be predetermined, created by smart home control system 320, or a combination of both predetermined and created categories. Examples of predetermined categories may include a non-controllable device category, which may contain other devices on the network that are not controllable by smart home control system 320, or devices on the home network, but are not smart home devices 405, such as desktop or laptop computers, or smartphones. Another predetermined category may include an unknown category, which may include devices on the network that the smart home control system 320 is unable to categorize based on the information received in block 104 or the determination made in block 106. The smart home control system 320 may be capable of generating a transmitting a graphical user interface to transmit to the user device to ask to the user to describe unknown devices on the network.

In some embodiments, the categories may be based on the function of the controllable smart devices. For example, one category may be environment, which may include smart thermostats, HVAC systems, heaters, humidifiers, dehumidifiers, and fans. Another example category may be lighting, which may include smart light switches, smart bulbs, and smart color changing bulbs. Other categories may include steady-state appliances (e.g., constantly-on appliances, such as a smart refrigerator), on-demand appliances (e.g., smart dishwasher, smart washing machine, smart dryer), security systems, cleaning systems (e.g., smart vacuum robot), pet systems, (e.g., automatic dog food dispenser and automatic litterbox), rechargeable devices (e.g., devices that need to be recharged on a schedule), and transportation (e.g., electric vehicles that need to be recharged on a schedule). Categories may optionally be created using other criteria besides function, such as typical time of use (e.g., times the device is typically turned on).

Smart plugs may be used to control a variety of devices. The smart home control system 320 may determine the device being controlled by the smart plug from the information received from the smart plug (e.g., if the smart plug transmits a current or amperage usage when the device is turned on, the smart home control system 320 may be able to predict whether the smart plug is controlling a lamp (low amperage) versus a heater (high amperage)). The smart home control system may be able to predict the device being controlled using usage patterns. For example, if the device is used 9 AM to 5 PM on weekdays, then the smart home control system 320 may predict the device is work related. Additionally, the smart home control system 320 may be able to predict the device based on seasonal usage patterns (e.g., Christmas lights only used at night during one month out of the year). After predicting what the smart plug is used for, smart home control system 320 may assign the smart plug to the appropriate category. If the smart home control system 320 is unsure of the category, then the smart home control system 320 may assign the smart plug to an unknown category.

According to some embodiments, the smart home control system 320 may system use algorithmic rules to generate the categories and/or categorize the devices on the network into the categories. The algorithmic rules may be based on goals selected by the user using a graphical user interface generated and transmitted to the user device. For example, the user may indicate using the user device that the devices should be categorized by function. In another example, the user may indicate using the user device that the devices should be categorized by general time of use (e.g., “while I am away,” “at night,” “during the day”). In some embodiments, the goal may be selected by the system based on the devices on the network automatically or based on the feedback of other users with similar devices.

According to some embodiments, the smart home control system 320 may use a machine learning model to categorize the devices into the categories. The machine learning model may use input data acquired from the router 404 or other sources to categorize the devices. The machine learning model may also use data from interacting with smart devices (e.g., data indicating the schedule of the smart device) when categorizing the device. The machine learning model may use training data or further input data provided from other prior users with similar devices (e.g., from database 360 or database 416) to categorize the devices. The machine learning model may use feedback provided by a user via a user device to further enhance categorization of smart devices (e.g., if the user changes the category of the smart device via a graphical user interface of a user device, information regarding changing the category may be used as feedback to the machine learning model to further enhance future categorization of smart home devices 405 for the user or other users). In some embodiments, the machine learning model may be an unsupervised machine learning model. The unsupervised machine learning model may use clustering to group devices based on how they are used. In some embodiments, the machine learning model may be a supervised machine learning model. The supervised machine learning model may categorize devices into categories that estimate use. The supervised machine learning model may receive feedback from a user.

The smart devices may be setup to follow a general or standard schedule. Once the devices are categorized, the smart home control system 320 may determine, for each category, and for each smart home device 405, a schedule for that device, if not already determined at block 106 (e.g., through communicating with the device, either via an API, or via the user's username and password). This may be completed using further algorithmic rules or additional machine learning models. Furthermore, additional machine learning models may be used and trained per category (e.g., each category may have a dedicated machine learning model trained for that particular category, or a “category-specific machine learning model”). In some embodiments, the category-specific machine learning models may be unsupervised machine learning models. The unsupervised machine learning models may use clustering. In some embodiments, the category-specific machine learning models may be supervised machine learning models. The supervised machine learning models may receive feedback from a user. The category-specific machine learning models may be trained based on other user data indicating what schedules other users have devices in that category typically on (e.g., for the HVAC category, for other users in the nearby area, when the user is detected to not be at home and not going to return home soon, the HVAC system is set to 26 degrees Celsius). The smart home control system 320 may use the category-specific machine learning models to compare the schedule of the devices in the category to the other user data. Smart home control system 320 may then optimize the schedule of operating the devices by communicating with the individual devices to change the schedule of individual devices based on the comparison of the category machine learning models according to established goals. If a smart device does not have a predefined schedule, then the smart home control system 320 may set a predefined schedule for the device.

According to some embodiments, the smart home control system 320 may generate a first graphical user interface displaying the list of devices connected to the home network of the user, the list of devices categorized into the function-based categories, and prompting the user to provide configuration information regarding the one or more controllable smart devices, transmit the first graphical user interface to a user device for display. The smart home control system 320 may receive, via the first graphical user interface of the user device, the configuration information for the one or more controllable smart devices, update the function-based categories and update the list of devices based on the configuration information. The smart home control system 320 may generate an updated first graphical user interface displaying the updated list of devices categorized into the updated function-based categories and transmit the updated first graphical user interface to the user device for display. The smart home control system 320 may reorder or recategorize the devices within the list of devices according to configuration information received from the smart devices. The smart home control system 320 may receive configuration information regarding unknown devices. This may be used to categorize and generate a schedule for the unknown devices. The unknown device may then be placed in the appropriate category in the list in the updated first graphical user interface.

In block 110, the smart home control system 320 may receive user data. The user data may comprise transaction data, which may be transaction card data. The transaction card data may include credit card data or debit card data. Transaction card data may include purchase-level information (e.g., items purchased, quantity of items purchased, amount or cost of each item, total amount charged). The transaction card data may include transaction information such as a pre-authorization (e.g., for a hotel reservation). The transaction card data may include the location of the merchant or transaction (which may be used to infer a location of the user). The transaction card data may include information if the card was or was not present at the transaction. The user data may comprise data associated with an account. The account may be a bank account, financial account, or transaction account. The user data may include user activity at an automated teller machine (ATM), such as checking a balance. The user data may include a flight reservation. User data may also include demographic or location information about the user (e.g., a home address, or global position satellite (GPS) location information from a user's mobile device). The user may also be able to optionally input additional user data using an interactive graphical user interface. Additional user data may include an approximate schedule of the user (e.g., if the user works Monday through Friday, the user may mark the approximate times they expect to be home), goals of the user (e.g., reducing electricity usage), connecting the smart home control system 320 to other users who also reside in the home (thereby also connecting the user data and transaction data of those users to the system as well). Additional user data may also include email information or email data (e.g., the user may give permission for smart home system 320 to parse through email data).

In block 112, the smart home control system 320 may determine a duration of an absence of a user in the home based on the user data. While the user is at home, the smart home control system 320 may allow smart devices to operate on a general or standard schedule or as directed by the user. The smart home control system 320 may know that the user is home by the GPS location indicated on the user's mobile device matching the home address of the user, or through the input of a security system, or other smart device (e.g., if the smart device indicates to smart home control system 320 that a physical user has changed settings, for example, turning a light from off to on). When the user leaves the home, the smart home control system 320 may determine a return time estimate for the user. The user leaving the home may be indicated by a number of events including, but not limited to: arming a security system, the GPS location of the user's mobile device no longer matching the address of the user's home, locking a smart lock, the video input from a smart doorbell (e.g., detecting that the user is leaving the home), opening and closing a smart garage door, or transaction data indicating the presence of the user at a location other than the home (e.g., a card-present transaction at a coffee shop). Another indication of the user leaving the home may include transaction data regarding a transaction indicating that the user will be absent (e.g., a flight purchase that is dated for the future implies that the user will be gone at the flight date and time as well as the duration of the absence if the purchase includes a return flight). The duration of the absence and/or return time estimate may be in the near or distant future (e.g., the system may estimate that the user will be returning from a shopping trip in less than an hour, or the system may estimate that the user will be returning from a vacation in three weeks).

The smart home control system 320 may determine a duration of the absence of the user by analyzing the transaction data. For example, if the transaction data comprises credit card data, the credit card data may show that the user made a purchase at a convenience store 5 miles from the user's home at 5:36 PM. From the credit card data, smart home control system 320 may determine that the user may likely be home by 6:00 PM, based on the user's previous patterns of stopping at this convenience store before returning home, and current traffic data, which the smart home control system 320 may receive from a server. In another example, the credit card data shows that the user made a purchase an electronics store 50 miles away at 7:30 PM. The smart home control system 320 may determine that, based on this information, the user is likely to get home at 9:00 PM. In another example, the credit card data shows that user made a purchase at a hotel 500 miles away at 3:00 PM. The smart home control system 320 may determine that, based on this information, the user is not likely to be home until the next day. The smart home control system 320 may generate an estimated time the user is expected to return. Alternatively, the smart home control system 320 may generate a binary response to the question “is the user going to return to the home tonight?” The smart home control system 320 may generate a response that is a combination of two or more of the above methodologies. For example, the smart home control system 320 predicts that the user is going to return home at 7:00 PM until it receives data suggesting that the user is not coming home that night, so the system determines that the user is coming home the next day (or alternatively “in the future”). The smart home control system 320 may set a time or event (e.g., the receipt of new transaction data) to reevaluate the duration of the user's absence.

The user data used to determine the duration of the absence of the user may include travel data. The travel data may be determined from the transaction data. For example, the user may have transaction data indicating a credit card purchase for airline ticket. In some cases, transaction data may indicate the departure airport and arrival airport and the associated dates and times of departure and arrival, which can be used by smart home control system 320 to determine the duration of the absence of the user. In other cases, the transaction data may not directly state travel plans, and the duration of the absence may have to be determined from the transaction data and other sources.

According to some embodiments, the smart home control system 320 may use a machine learning model to determine the duration of the absence of the user in the home based on the user data and/or transaction data. According to some embodiments, the user data used by the second machine learning model may include travel data associated with the user. The machine learning model may be able to predict the duration of the absence of the user (e.g., with an output of the expected return of the user at a certain time or after a certain number of hours). Alternatively, the machine learning model may output a binary response of whether the user will return to the home that night based on the user data. The binary response may be a determination of whether the user will return to the home in a set number of hours (e.g., 6 hours or 24 hours). The user data and/or transaction data may be used as inputs to the machine learning model. The machine learning model may be trained with prior transaction data from the user or transaction data associated other users. The machine learning model may be trained from user data and/or transaction data across a user segment or customer segment. According to some embodiments, the machine learning model may use all of the user data from two days prior and select parts of the user data from six months prior. The machine learning model may receive more input data iteratively, which can be used to make a new prediction of the expected return of the user.

In some embodiments, the smart home control system 320 may create an initial prediction of how long the user is expected to be away from home for/the duration of the absence of the user based on a first receipt of user data, such as the receipt of first transaction data. On a transaction-by-transaction basis, as more transaction information is received, smart home control system 320 may revise the estimated duration of the absence of the user. In an alternative embodiment, the smart home control system 320 may create an initial prediction and then create a revised prediction on an hourly basis, based on received revised and new user data.

In block 114, the smart home control system 320 may change the schedule of one or more controllable smart devices based on the category and the duration of the absence of the user. The smart home control system 320 may change the operating schedule of smart home devices 405 while the user is away from the home to save energy. When the smart home control system 320 determines that the user is set to return at a time of that day in block 112, the smart home control system 320 may change the schedule of one or more smart devices in order to prepare the home for the user's return. This may involve, in some embodiments, utilizing the category-specific machine learning models to analyze the schedules on a categorical basis to aid smart home control system 320 in correctly preparing the home for the user's return. The category machine learning models may be trained with data other users.

In some embodiments, the schedule of devices may be based on a standard schedule. The standard schedule may contain options based on events. Events may be, for example, a certain amount of time after a user leaves, at a certain time of day, a certain amount of time before a user arrives, or within a set period of time (e.g., every X number of days). The standard schedule may be based on data previously received from the smart devices, a standard schedule set by smart home control system 320 (which may be influenced by other user schedules), or a schedule preset by the user. The smart home control system 320 may adjust the standard schedule as needed, or change the schedule certain devices, or categories of devices, from the standard schedule in response to determining a duration of the absence of the user. For example, if the smart home control system 320 determines that user is going to be out of town for 3 weeks, the smart home control system 320 may cancel daily automated vacuum cleanings at 12:00 PM. Instead, the smart home control system 320 may schedule a single automated vacuum cleaning the day before the user is expected to return. In another example, if the smart home control system 320 receives transaction data indicating that the user has just made a large purchase at a grocery store, the smart home control system 320 may send instructions to setup the smart fridge in the user's home to precool the refrigerator and freezer in anticipation of the doors being opened more than typical.

The smart home control system 320 may have multiple options for changing the schedule or may change the device schedule as new information is received. In an example, the user may leave the home to go to work at 7:45 AM. The smart home control system 320 may detect that the smart door lock was unlocked and then locked again, or that the camera on the automated doorbell detected a person leaving the residence. Based on prior user data over the last month, the smart home control system 320 may determine that the duration of the absence of the user is 10 hours (user will return at 5:45 PM), based on a normal workday schedule for the user. During this time, the smart home control system 320 assigns the controllable smart devices to run on a typical schedule. In this example, the HVAC system turns up 3 degrees while the user is away and runs the dishwasher at a discretionary time while the user is out. At 12:30 PM, the user purchases a sandwich from a local shop. Smart home control system 320 reassesses the duration of the absence of the user based on new transaction data received from the sandwich purchase. Since the user frequently purchases a lunch on a typical workday, this purchase does not have an effect on the estimated return time of the user, and the schedules of the controllable smart devices are unchanged. At 4:45 PM, the smart home control system 320 receives transaction data indicating that the user went to a doctor's office. Since this is an abnormal purchase compared to a normal workday, and the doctor's office was an additional 20 miles from the user's home, the smart home control system 320 estimates that the user will now be home at 6:15 PM. Accordingly, the smart home control system 320 changes the schedule of the HVAC system to begin precooling the home and running the dishwasher at 5:45 PM (30 minutes before the arrival time of the user) instead of previously at 5:15 PM. At 5:10 PM, the smart home control system 320 receives transaction data of the user from a gas station 35 miles away from the user's home. The smart home control system 320 compares the location of the gas station to the doctor's office (the last known transaction) and predicts that the user is driving away from home. The smart home control system determines the duration of the absence of the user will be longer than one day (e.g., that the user will not be returning to the home today). The smart home control system changes the schedule of the smart devices and instructs the smart devices to leave the HVAC system at the elevated temperature setting and the leave the dishwasher off.

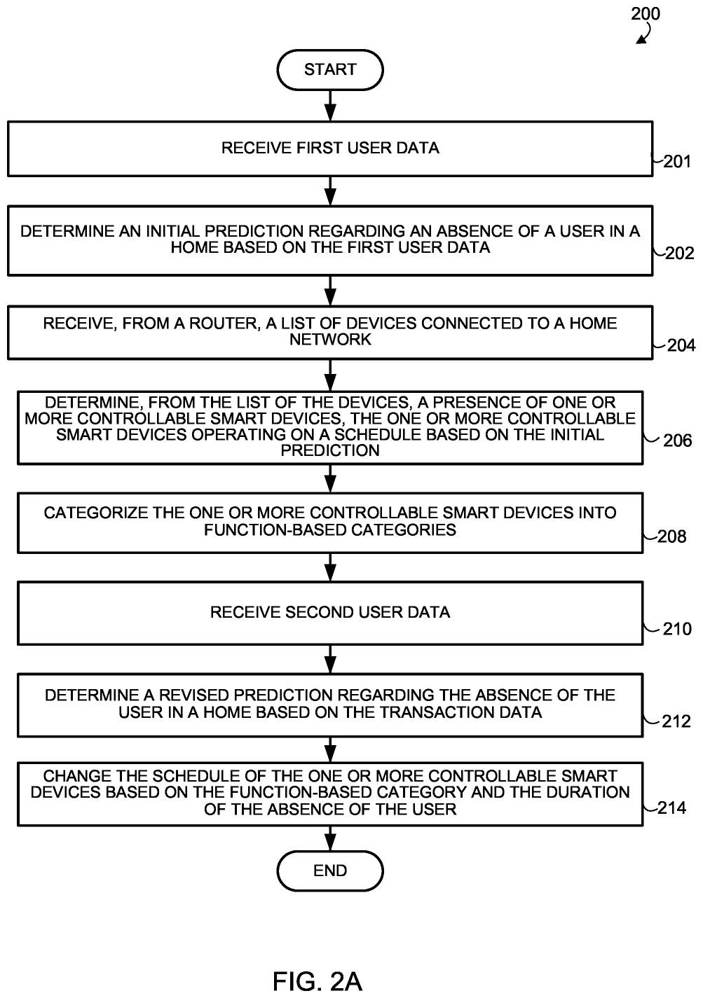

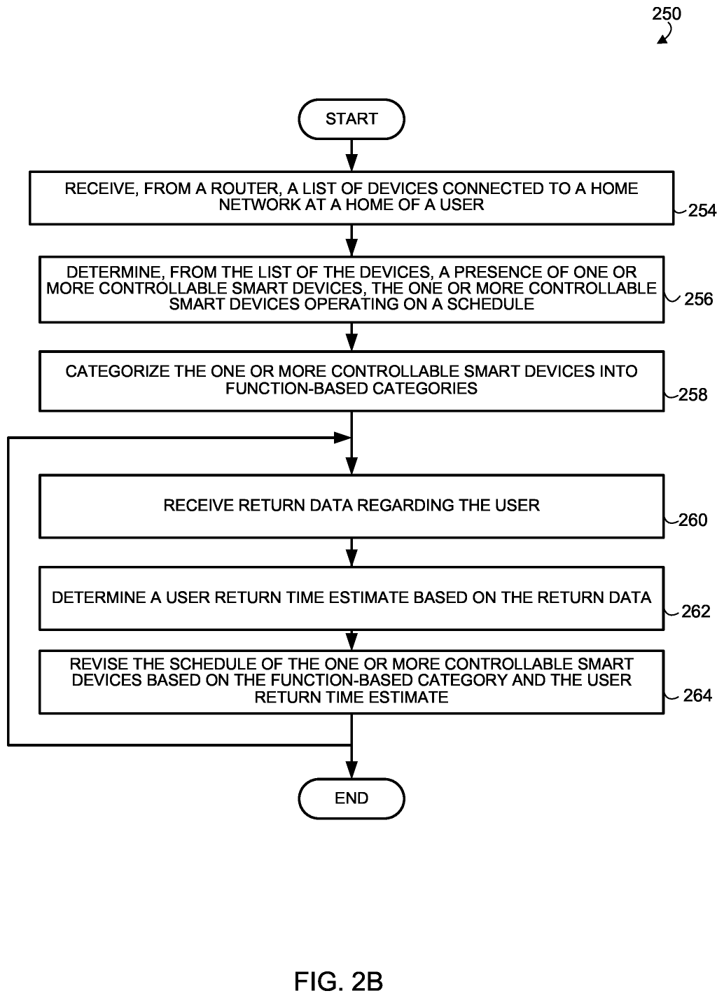

FIG. 2A is a flow diagram illustrating an exemplary method 200 for controlling smart home devices, in accordance with certain embodiments of the disclosed technology. The steps of method 200 may be performed by one or more components of the system 400 (e.g., smart home control system 320 or web server 410 of data system 408 or user device 402), as described in more detail with respect to FIGS. 3 and 4.

Method 200 of FIG. 2A is similar to method 100 of FIG. 1. The descriptions of blocks 204, 206, 208, 210, 212, and 214 in method 200 are similar to the respective descriptions of blocks 104, 106, 108, 110, 112 and 114 of method 100 and those descriptions are not repeated herein for brevity. Aspects of blocks 201 and 202 are similar to blocks 110 and 112 and are described below.

In method 200, the smart home control system 320 may receive first user data and develop an initial prediction regarding the absence of a user. In block 201, the smart home control system 320 may receive first user data. According to some embodiments, this may be achieved in a manner similar to that described above with respect to block 110 of method 100. In block 202, the smart home control system 320 may determine an initial prediction regarding an absence of a user from a home based on the first user data. According to some embodiments, this may be achieved in a manner similar to that described above with respect to block 112 of method 100. In block 210, the smart home control system 320 may receive second user data. This may be largely similar to the first user data or an update regarding a new transaction associated with the user's account. In block 212, the smart home control system 320 may determine a revised prediction regarding the absence of the user in the home based on the second user data. Responsive to the revised prediction being different from the initial prediction beyond a threshold, the smart home control system 320 may change the schedule to the smart devices to reflect the revised prediction. In some embodiments, the threshold may be a predetermined difference in the estimated return time of the user (e.g., the user is returning 10 minutes, 1 hour, or 1 day later than expected). Responsive to the revised prediction not being different from the initial prediction beyond the threshold, the smart home control system 320 may not change the schedule of the smart devices.

According to some embodiments, the initial prediction regarding the absence of the user in the home and the revised prediction regarding the absence of the user in the home may be a binary output. According to some embodiments, the binary output may be a determination of whether the user will be at the home on an evening of the initial prediction and the revised prediction.

According to some embodiments, the schedule of the one or more controllable smart devices may be altered based on the output of a machine learning model, based on inputs of the first user data, the second user data, and the function-based category of the one or more controllable smart devices, and trained with historical user data.

FIG. 2B is a flow diagram illustrating an exemplary method 250 for controlling smart home devices, in accordance with certain embodiments of the disclosed technology. The steps of method 250 may be performed by one or more components of the system 400 (e.g., smart home control system 320 or web server 410 of data system 408 or user device 402), as described in more detail with respect to FIGS. 3 and 4.

Method 250 of FIG. 2B is similar to method 100 of FIG. 1. The descriptions of blocks 254, 256, 258, 260, 262, and 264 in method 250 are largely similar to the respective descriptions of blocks 104, 106, 108, 110, 112, and 114 of method 100 and are not repeated herein for brevity.

Blocks 260, 262, and 264 of method 250 may be performed iteratively. Accordingly, smart home control system 320 may constantly, by event, or by time schedule repeat. Therefore, the return time estimate may be updated as new return data is received. The return time estimate may be used to revise the schedule of the smart devices.

According to some embodiments, blocks 260, 262, and 264 may be performed iteratively on an event basis. According to some embodiments blocks 260, 262, and 264 may be performed iteratively on a time basis.

According to some embodiments, the smart home control system 320 may generate a graphical user interface displaying the list of devices connected to the home network of the user. The list of devices may display the schedule for each of the one or more controllable smart devices based on the user return time estimate and/or the user return time estimate. The smart home control system 320 may transmit the graphical user interface to a user device for display. The smart home control system 320 receive, via the graphical user interface of the user device, an indication to change the user return time estimate from the user device. In response to receiving the indication to manually change the user return time estimate, the smart home control system 320 may update the user return time estimate and the schedule for each of the one or more controllable smart devices based on the indication. The smart home control system 320 may generate an updated graphical user interface displaying the updated schedule for each of the one or more controllable smart devices and transmit the updated graphical user interface to the user device for display.

FIG. 3 is a block diagram of an example smart home control system 320 used to control smart home devices according to a determined schedule according to an example implementation of the disclosed technology. According to some embodiments, the user device 402 and web server 410, as depicted in FIG. 4 and described below, may have a similar structure and components that are similar to those described with respect to smart home control system 320 shown in FIG. 3. As shown, the smart home control system 320 may include a processor 310, an input/output (I/O) device 370, a memory 330 containing an operating system (OS) 340 and a program 350. In certain example implementations, the smart home control system 320 may be a single server or may be configured as a distributed computer system including multiple servers or computers that interoperate to perform one or more of the processes and functionalities associated with the disclosed embodiments. In some embodiments smart home control system 320 may be one or more servers from a serverless or scaling server system. In some embodiments, the smart home control system 320 may further include a peripheral interface, a transceiver, a mobile network interface in communication with the processor 310, a bus configured to facilitate communication between the various components of the smart home control system 320, and a power source configured to power one or more components of the smart home control system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth14 port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the smart home control system 320 may include one or more storage devices configured to store information used by the processor 310 (or other components) to perform certain functions related to the disclosed embodiments. In one example, the smart home control system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The smart home control system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the smart home control system 320 may include the memory 330 that may include one or more programs 350 to perform one or more functions of the disclosed embodiments. For example, in some embodiments, the smart home control system 320 may additionally manage dialogue and/or other interactions with the customer via a program 350.

The processor 310 may execute one or more programs 350 located remotely from the smart home control system 320. For example, the smart home control system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a smart home control system database 360 for storing related data to enable the smart home control system 320 to perform one or more of the processes and functionalities associated with the disclosed embodiments.

The smart home control system database 360 may include stored data relating to status data (e.g., average session duration data, location data, idle time between sessions, and/or average idle time between sessions) and historical status data. According to some embodiments, the functions provided by the smart home control system database 360 may also be provided by a database that is external to the smart home control system 320, such as the database 416 as shown in FIG. 4.

The smart home control system 320 may also be communicatively connected to one or more memory devices (e.g., databases) locally or through a network. The remote memory devices may be configured to store information and may be accessed and/or managed by the smart home control system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The smart home control system 320 may also include one or more I/O devices 370 that may comprise one or more interfaces for receiving signals or input from devices and providing signals or output to one or more devices that allow data to be received and/or transmitted by the smart home control system 320. For example, the smart home control system 320 may include interface components, which may provide interfaces to one or more input devices, such as one or more keyboards, mouse devices, touch screens, track pads, trackballs, scroll wheels, digital cameras, microphones, sensors, and the like, that enable the smart home control system 320 to receive data from a user (such as, for example, via the user device 402).

In examples of the disclosed technology, the smart home control system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The smart home control system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The smart home control system 320 may be configured to adjust model parameters during training. Model parameters may include weights, coefficients, offsets, or the like. Training may be supervised or unsupervised.

The smart home control system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The smart home control system 320 may be configured to optimize statistical models using known optimization techniques.

Furthermore, the smart home control system 320 may include programs configured to retrieve, store, and/or analyze properties of data models and datasets. For example, smart home control system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The smart home control system 320 may include algorithms to determine a data type, key-value pairs, row-column data structure, statistical distributions of information such as keys or values, or other property of a data schema may be configured to return a statistical profile of a dataset (e.g., using a data-profiling model). The smart home control system 320 may be configured to implement univariate and multivariate statistical methods. The smart home control system 320 may include a regression model, a Bayesian model, a statistical model, a linear discriminant analysis model, or other classification model configured to determine one or more descriptive metrics of a dataset. For example, smart home control system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The smart home control system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, smart home control system 320 may be configured to generate a similarity metric representing a measure of similarity between data in a dataset. A similarity metric may be based on a correlation, covariance matrix, a variance, a frequency of overlapping values, or other measure of statistical similarity.

The smart home control system 320 may be configured to generate a similarity metric based on data model output, including data model output representing a property of the data model. For example, smart home control system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The smart home control system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The smart home control system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, smart home control system 320 is configured to generate and/or train a classification model to classify a dataset, consistent with disclosed embodiments.

The smart home control system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the smart home control system may analyze information applying machine-learning methods.

While the smart home control system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the smart home control system 320 may include a greater or lesser number of components than those illustrated.

FIG. 4 is a block diagram of an example system that may be used to view and interact with data system 408, according to an example implementation of the disclosed technology. The components and arrangements shown in FIG. 4 are not intended to limit the disclosed embodiments as the components used to implement the disclosed processes and features may vary. As shown, data system 408 may interact with a user device 402 via a network 406. In certain example implementations, the data system 408 may include a local network 412, a smart home control system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the data system 408. In some embodiments, the user device 402 may include or incorporate electronic communication devices for hearing or vision impaired users.

In some embodiments, the smart home control system 320 may receive data from a router 404, which may be connected to one or more devices, a subset of which may be controllable smart home devices 405 (405A, 405B, 405C). The router 404 may be located in the home or residence of the user. The router 404 may provide internet access to the smart home devices 405 and/or the user device. In other embodiments, smart home control system 320 and/or data system 408 may operate in part or in whole on the processor and memory of the router 404. In other embodiments, smart home control system 320 and/or data system 408 may operate in part or in whole on the processor and memory of the user device 402. The smart home control system 320 may be used to control devices in locations other than the user's home, such as in an office.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the data system 408. Users may also include a homeowner, or a person who resides in the dwelling where the smart home devices 405 and/or router 404 are located. Users may also include service technicians or temporary residents (e.g., where a user is a temporary renter of a dwelling). According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The smart home control system 320 may include programs (scripts, functions, algorithms) to configure data for visualizations and provide visualizations of datasets and data models on the user device 402. This may include programs to generate graphs and display graphs. The smart home control system 320 may include programs to generate histograms, scatter plots, time series, or the like on the user device 402. The smart home control system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The data system 408 may be associated with and optionally controlled by one or more entities such as a business, corporation, individual, partnership, or any other entity that provides one or more of goods, services, and consultations to individuals such as customers. In some embodiments, the data system 408 may be controlled by a third party on behalf of another business, corporation, individual, partnership. The data system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the smart home control system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™

The local network 412 may include any type of computer networking arrangement used to exchange data in a localized area, such as WiFi, Bluetooth™, Ethernet, and other suitable network connections that enable components of the data system 408 to interact with one another and to connect to the network 406 for interacting with components in the system 400 environment. In some embodiments, the local network 412 may include an interface for communicating with or linking to the network 406. In other embodiments, certain components of the data system 408 may communicate via the network 406, without a separate local network 406.

The data system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access data system 408 using the cloud computing environment. User device 402 may be able to access data system 408 using specialized software. The cloud computing environment may eliminate the need to install specialized software on user device 402.

In accordance with certain example implementations of the disclosed technology, the data system 408 may include one or more computer systems configured to compile data from a plurality of sources the smart home control system 320, web server 410, and/or the database 416. The smart home control system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 410, a smart home control system 320, a database 416, and a local network 412, in some embodiments, some or all of these functions may be carried out by a single computing device.

### Example Use Case

The following example use case describes an example of a typical user flow pattern. This section is intended solely for explanatory purposes and not in limitation.

In one example, Max has three smart home devices 405: a light controller, a smart HVAC system, and a smart washing machine. Smart control system 320 receives from Max's home router 404 a list of network connected devices including a home computer, the light controller, the smart HVAC system, and the smart washing machine (block 104). Smart control system 320 determines and classifies, using information from a database, that the smart HVAC system is an environmental control system, the smart washing machine is an appliance, the lighting controller is for ambiance, and the computer is an uncontrollable device (blocks 106 and 108). Max leaves at 10:00 AM, and shopping, the system defaults to a standard schedule and instructs the devices to: turn off the lights, set the HVAC to a high setting (as it is hot outside in Max's area), and plan to start the washing machine at 4:00 PM before Max's 5:00 PM estimated return. Max purchases a shirt at a store. The smart control system 320 receives data that Max made a purchase for a shirt at a mall (block 110). The smart control system 320 determines that Max's return time or duration of absence is unaffected (block 112). Max then goes to the airport checks-in for a flight to Europe and purchases a seat upgrade. The smart control system 320 receives data that Max made seat upgrade purchase at the airport for greater than $400 (block 260). The smart control system 320 determines that Max is not returning to the house that day (block 262). The smart control system 320 directs the smart devices to: increase the temperature of the HVAC for a long-term unoccupied time, turn on different lights periodically at night so that someone appears home, and cancel all scheduled washing machine cycles (block 264).

In some examples, disclosed systems or methods may involve one or more of the following clauses:
Clause 1: A smart home control system comprising: one or more processors; memory in communication with the one or more processors and storing instructions that are configured to cause the smart home control system to: receive, from a router, a list of devices connected to a home network in a home; determine, from the list of devices, a presence of one or more controllable smart devices, the one or more controllable smart devices operating on a schedule; categorize the one or more controllable smart devices into function-based categories; receive user data; determine a duration of an absence of a user in the home based on the user data; and change the schedule of the one or more controllable smart devices based on the function-based category and the duration of the absence of the user.
Clause 2: The smart home control system of clause 1, wherein the smart home control system uses a first machine learning model to categorize the one or more controllable smart devices into the function-based categories.
Clause 3: The smart home control system of clause 1, wherein the smart home control system uses algorithmic rules to categorize the one or more controllable smart devices into the function-based categories.
Clause 4: The smart home control system of clause 1, wherein the smart home control system uses a second machine learning model to determine the duration of the absence of the user in the home based on the user data.
Clause 5: The smart home control system of clause 4, wherein the user data used by the second machine learning model comprises travel data associated with the user.
Clause 6: The smart home control system of clause 4, wherein the second machine learning model uses all of the user data from two days prior and select parts of the user data from six months prior.
Clause 7: The smart home control system of clause 1, wherein the smart home control system uses a series of machine learning models, one for each of the function-based categories, to change the schedule of the controllable smart devices, wherein the series of machine learning models are trained with data other users.
Clause 8: The smart home control system of clause 1, wherein the memory stores further instructions that are configured to cause the smart home control system to: generate a first graphical user interface displaying the list of devices connected to the home network of the user, the list of devices categorized into the function-based categories, and prompting the user to provide configuration information regarding the one or more controllable smart devices; transmit the first graphical user interface to a user device for display; receive, via the first graphical user interface of the user device, the configuration information for the one or more controllable smart devices; update the function-based categories and update the list of devices based on the configuration information; generate an updated first graphical user interface displaying the updated list of devices categorized into the updated function-based categories; and transmit the updated first graphical user interface to the user device for display.
Clause 9: A smart home control system comprising: one or more processors; memory in communication with the one or more processors and storing instructions that are configured to cause the smart home control system to: receive first user data; determine an initial prediction regarding an absence of a user from a home based on the first user data; receive, from a router, a list of devices connected to a home network; determine, from the list of devices, a presence of one or more controllable smart devices, the one or more controllable smart devices operating on a schedule based on the initial prediction; categorize the one or more controllable smart devices into function-based categories; receive second user data; determine a revised prediction regarding the absence of the user in the home based on the second user data; and change the schedule of the one or more controllable smart devices based on the function-based category and a duration of the absence of the user.
Clause 10: The smart home control system of clause 9, wherein the initial prediction regarding the absence of the user in the home and the revised prediction regarding the absence of the user in the home is a binary output.
Clause 11: The smart home control system of clause 10, wherein the binary output is a determination of whether the user will be at the home on an evening of the initial prediction and the revised prediction.
Clause 12: The smart home control system of clause 9, wherein the first user data and the second user data comprise location data, wherein the location data comprises a flight reservation.
Clause 13: The smart home control system of clause 9, wherein the schedule of the one or more controllable smart devices comprises multiple options based on the duration of the absence of the user.
Clause 14: The smart home control system of clause 9, wherein the schedule of the one or more controllable smart devices is changed by a machine learning model, based on the first user data, the second user data, and the function-based category of the one or more controllable smart devices, and trained with historical user data.
Clause 15: A smart home control system comprising: one or more processors; memory in communication with the one or more processors and storing instructions that are configured to cause the smart home control system to: receive, from a router, a list of devices connected to a home network at a home of a user; determine, from the list of devices, a presence of one or more controllable smart devices, the one or more controllable smart devices operating on a schedule; categorize the one or more controllable smart devices into function-based categories; iteratively perform the following steps while the user is away from the home: receive return data regarding the user; determine a user return time estimate based on the return data; and revise the schedule of the one or more controllable smart devices based on the function-based category and the user return time estimate.
Clause 16: The smart home control system of clause 15, wherein the return data includes user data from an account associated with the user.
Clause 17: The smart home control system of clause 16, wherein receiving the return data regarding the user, determining the user return time estimate based on the return data, and revising the schedule of the one or more controllable smart devices based on the function-based category and the user return time estimate are performed iteratively on an event basis.
Clause 18: The smart home control system of clause 15, wherein the return data includes location data.
Clause 19: The smart home control system of clause 15, wherein receiving the return data regarding the user, determining the user return time estimate based on the return data, and revising the schedule of the one or more controllable smart devices based on the function-based category and the user return time estimate are performed iteratively on a time basis.
Clause 20: The smart home control system of clause 15, wherein the memory stores further instructions that are configured to cause the smart home control system to: generate a first graphical user interface displaying the list of devices connected to the home network of the user, the list of devices categorized into the function-based categories, and displaying the schedule for each of the one or more controllable smart devices based on the user return time estimate; transmit the first graphical user interface to a user device for display; receive, via the first graphical user interface of the user device, an indication to change the user return time estimate; update the user return time estimate and the schedule for each of the one or more controllable smart devices based on the indication; generate an updated first graphical user interface displaying the updated schedule for each of the one or more controllable smart devices; and transmit the updated first graphical user interface to the user device for display.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system.” “server.” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments.” “example embodiment,” “various embodiments,” “one implementation.” “an implementation,” “example implementation,” “various implementations.” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A smart home control system comprising:
one or more processors;
memory in communication with the one or more processors and storing instructions that are configured to cause the smart home control system to:
receive, from a router, a list of devices connected to a home network in a home;
determine, from the list of devices, a presence of one or more controllable smart devices, the one or more controllable smart devices operating on a schedule;
categorize the one or more controllable smart devices into function-based categories;
receive user data;
determine a duration of an absence of a user in the home based on the user data; and
change the schedule of the one or more controllable smart devices based on the function-based category and the duration of the absence of the user.

2. The smart home control system of claim 1, wherein the smart home control system uses a first machine learning model to categorize the one or more controllable smart devices into the function-based categories.

3. The smart home control system of claim 1, wherein the smart home control system uses algorithmic rules to categorize the one or more controllable smart devices into the function-based categories.

4. The smart home control system of claim 1, wherein the smart home control system uses a second machine learning model to determine the duration of the absence of the user in the home based on the user data.

5. The smart home control system of claim 4, wherein the user data used by the second machine learning model comprises travel data associated with the user.

6. The smart home control system of claim 4, wherein the second machine learning model uses all of the user data from two days prior and select parts of the user data from six months prior.

7. The smart home control system of claim 1, wherein the smart home control system uses a series of machine learning models, one for each of the function-based categories, to change the schedule of the controllable smart devices, wherein the series of machine learning models are trained with data other users.

8. The smart home control system of claim 1, wherein the memory stores further instructions that are configured to cause the smart home control system to:
generate a first graphical user interface displaying the list of devices connected to the home network of the user, the list of devices categorized into the function-based categories, and prompting the user to provide configuration information regarding the one or more controllable smart devices;
transmit the first graphical user interface to a user device for display;
receive, via the first graphical user interface of the user device, the configuration information for the one or more controllable smart devices;
update the function-based categories and update the list of devices based on the configuration information;
generate an updated first graphical user interface displaying the updated list of devices categorized into the updated function-based categories; and
transmit the updated first graphical user interface to the user device for display.

9. A smart home control system comprising:
one or more processors;
memory in communication with the one or more processors and storing instructions that are configured to cause the smart home control system to:
receive first user data;
determine an initial prediction regarding an absence of a user from a home based on the first user data;
receive, from a router, a list of devices connected to a home network;
determine, from the list of devices, a presence of one or more controllable smart devices, the one or more controllable smart devices operating on a schedule based on the initial prediction;
categorize the one or more controllable smart devices into function-based categories;
receive second user data;
determine a revised prediction regarding the absence of the user in the home based on the second user data; and
change the schedule of the one or more controllable smart devices based on the function-based category and a duration of the absence of the user.

10. The smart home control system of claim 9, wherein the initial prediction regarding the absence of the user in the home and the revised prediction regarding the absence of the user in the home is a binary output.

11. The smart home control system of claim 10, wherein the binary output is a determination of whether the user will be at the home on an evening of the initial prediction and the revised prediction.

12. The smart home control system of claim 9, wherein the first user data and the second user data comprise location data, wherein the location data comprises a flight reservation.

13. The smart home control system of claim 9, wherein the schedule of the one or more controllable smart devices comprises multiple options based on the duration of the absence of the user.

14. The smart home control system of claim 9, wherein the schedule of the one or more controllable smart devices is changed by a machine learning model, based on the first user data, the second user data, and the function-based category of the one or more controllable smart devices, and trained with historical user data.

15. A smart home control system comprising:
one or more processors;
memory in communication with the one or more processors and storing instructions that are configured to cause the smart home control system to:
receive, from a router, a list of devices connected to a home network at a home of a user;
determine, from the list of devices, a presence of one or more controllable smart devices, the one or more controllable smart devices operating on a schedule;
categorize the one or more controllable smart devices into function-based categories;
iteratively perform the following steps while the user is away from the home:
receive return data regarding the user;
determine a user return time estimate based on the return data; and
revise the schedule of the one or more controllable smart devices based on the function-based category and the user return time estimate.

16. The smart home control system of claim 15, wherein the return data includes user data from an account associated with the user.

17. The smart home control system of claim 16, wherein receiving the return data regarding the user, determining the user return time estimate based on the return data, and revising the schedule of the one or more controllable smart devices based on the function-based category and the user return time estimate are performed iteratively on an event basis.

18. The smart home control system of claim 15, wherein the return data includes location data.

19. The smart home control system of claim 15, wherein receiving the return data regarding the user, determining the user return time estimate based on the return data, and revising the schedule of the one or more controllable smart devices based on the function-based category and the user return time estimate are performed iteratively on a time basis.

20. The smart home control system of claim 15, wherein the memory stores further instructions that are configured to cause the smart home control system to:
generate a first graphical user interface displaying the list of devices connected to the home network of the user, the list of devices categorized into the function-based categories, and displaying the schedule for each of the one or more controllable smart devices based on the user return time estimate;
transmit the first graphical user interface to a user device for display;
receive, via the first graphical user interface of the user device, an indication to change the user return time estimate;
update the user return time estimate and the schedule for each of the one or more controllable smart devices based on the indication;
generate an updated first graphical user interface displaying the updated schedule for each of the one or more controllable smart devices; and
transmit the updated first graphical user interface to the user device for display.
